(19) United States
(12) Patent Application Publication
(10) Pub. No.: US 2011/0295701 A1
(43) Pub. Date: Dec. 1, 2011

(54) WEB-BASED SYSTEM AND METHOD TO IMPLEMENT DIGITAL OUT-OF-HOME ADVERTISEMENTS

(76) Inventor: Justin Phan, Laguna Hills, CA (US)

(21) Appl. No.: 13/115,773

(22) Filed: May 25, 2011

Related U.S. Application Data
(60) Provisional application No. 61/347,959, filed on May 25, 2010.

(51) Int. Cl. G06Q 30/00

(52) U.S. Cl. 705/14.72

(57) ABSTRACT

A method and apparatus are disclosed to implement digital out-of-home advertisements. The method includes logging in an advertisement system. The method also includes starting an advertisement campaign. In addition, the method includes searching for locations where advertisements can be shown. The method further includes selecting and purchasing advertisement space. Furthermore, the method includes creating an advertisement from ad templates, and uploading and submitting the advertisement to an appropriate advertising network for display. In addition, the method includes managing information related to the advertisement campaign, and proof of play.

### CROSS-REFERENCE TO RELATED APPLICATIONS

The present application for patent claims the benefit of U.S. Provisional Patent Application Ser. No. 61/347,959, filed on May 25, 2010, entitled “A Web-based System and Method to Implement Digital Out-Of-Home Advertisements”.

### FIELD

This application relates generally to a web-based system and method to streamline, automate, and implement the digital out-of-home (DOOH) advertising process among multiple DOOR networks, venues and ad formats.

### BACKGROUND

Digital out-of-home advertising combines a rich television medium with the ability to select the targeted audience. The DOOR ads are entertaining and cannot be fast forwarded. There is need for a web based marketplace for DOOH advertising to bring together DOOH networks and advertisers to give advertisers access to ad space on various medium such as televisions at gas stations, elevators, grocery stores, and shopping malls, as well as screen space at movie theaters.

### SUMMARY

A method and apparatus are disclosed to implement digital out-of-home advertisements. The method includes logging in an advertisement system. The method also includes starting an advertisement campaign. In addition, the method includes searching for locations where advertisements can be shown. The method further includes selecting and purchasing advertisement space. Furthermore, the method includes creating an advertisement from ad templates, and uploading and submitting the advertisement to an appropriate advertising network for display. In addition, the method includes managing information related to the advertisement campaign, and proof of play.

### BRIEF DESCRIPTION OF THE DRAWINGS

FIGS. 1, 2, 3, 4, and 5 are simplified block diagrams of exemplary aspects of the web-based system to implement digital out-of-home advertisements according to one embodiment of the invention.

FIGS. 6 and 7 are flowcharts showing exemplary aspects of operations that may be performed to implement digital out-of-home advertisements according to one embodiment of the invention.

FIGS. 8, 9, 10, and 11 illustrate simplified user screens with exemplary aspects of the web-based system to implement digital out-of-home advertisement according to one embodiment of the invention.

### DETAILED DESCRIPTION

In one embodiment, a web-based implementation enables DOOH screen owners to post their advertising inventory for sale. In an alternative embodiment, the web-based implementation allows a potential advertiser to search for DOOH locations with available advertisement space that match target audience based on demographics and geographical locations. As an example, DOOH locations that fully match the advertiser's search criteria would be presented using icons in a pre-selected color (such as green) on a map, while DOOH locations that partially match the advertiser's search criteria would be presented in icons with a different pre-selected color (such as yellow) on the same map. The advertiser could then select the DOOH locations where they wish to advertise from the map or a list. In one embodiment, the web-based implementation presents a campaign summary that automatically computes information related to pricing, traffic, and demographic based on the selected DOOH locations.

In one embodiment, the advertiser could purchase advertising space at selected DOOH locations via a number payment options, including payment by credit card. Once the advertiser purchases and owns the advertising space, he could upload an advertisement. The web-based implementation would notify and send the advertising schedule and uploaded advertisement to the respective networks for scheduling.

In another embodiment, through the web-based implementation, the advertiser could generate proof-of-play reports, extend and renew advertising campaigns, and/or create his own advertisements from available advertisement templates.

In an alternative embodiment, the web-based implementation provides numerous advantageous functionalities, including (1) the ability to gather and present DOOH networks on one platform, (2) the capability to automatically compute and provide costs, impressions (i.e., opportunities to view an advertisement), demographic information, geographic information, advertisements programming, and/or creative guidelines for advertisements, (3) enabling the advertiser to purchase various forms of (example: Vertical Banner Space, Full Screen Video ad space, etc.) advertisements space over one or multiple DOOH networks by selecting preferred venues, (4) easy payment options (such as payment by credit card), (5) allowing the advertiser to directly upload and submit his advertisements as opposed to submissions by email, mail, or FTP, and (6) enabling the DOOH networks to organize and manage various advertising accounts efficiently by maintaining advertising campaigns generated through the web-based implementation, (7) allowing the advertiser to generate proof-of-play reports without having to submit requests for such reports to an advertising account manager or executive, (8) enabling the advertiser to extend or renew an advertising campaign via the web-based implementation without having to contact the advertising account manager or executive, and (9) mapping and presenting relevant advertising locations based on the locations' addresses.

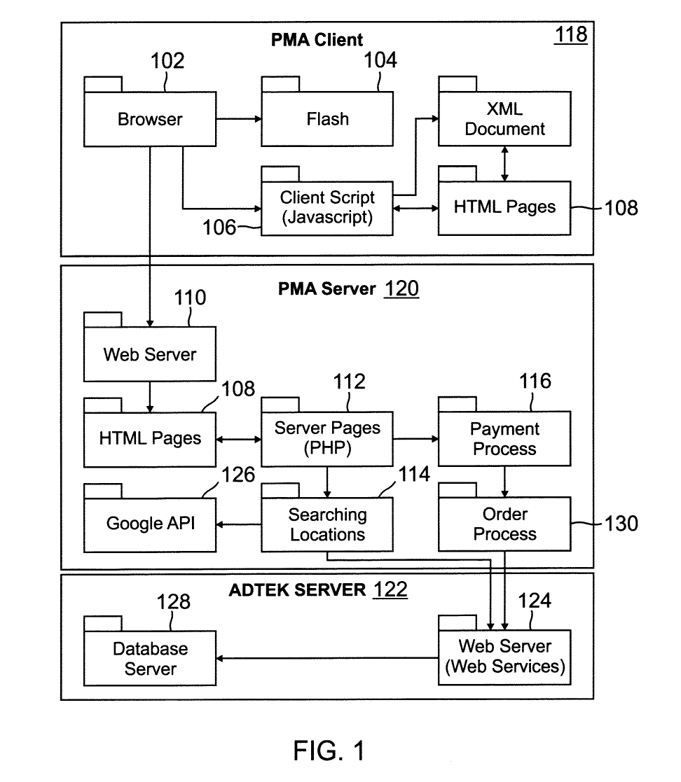

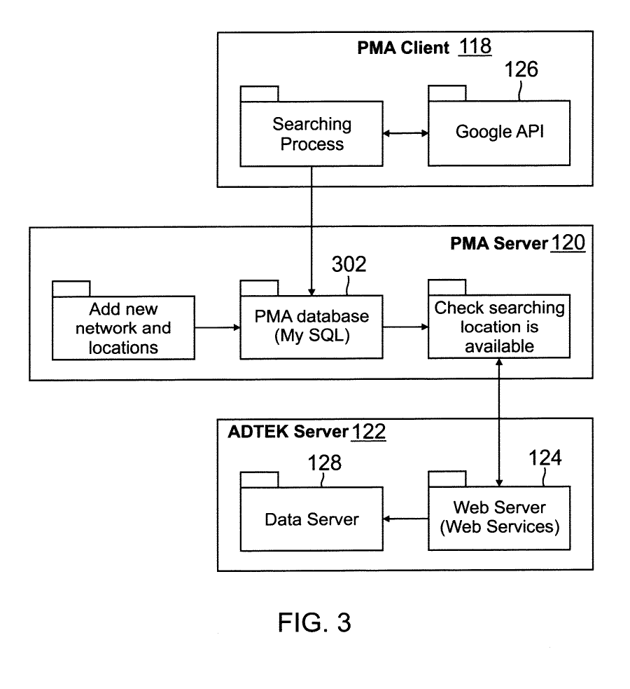

FIGS. 1, 2, 3, 4, and 5 are simplified block diagrams of exemplary aspects of the web-based system to implement digital out-of-home advertisements according to one aspect of the invention. In FIGS. 3, 4, and 5, the Advertisement Network server 122 represents an exemplary server for a DOOH network. In practice, other specific DOOH network servers could take the place of the Advertisement Network server 122.

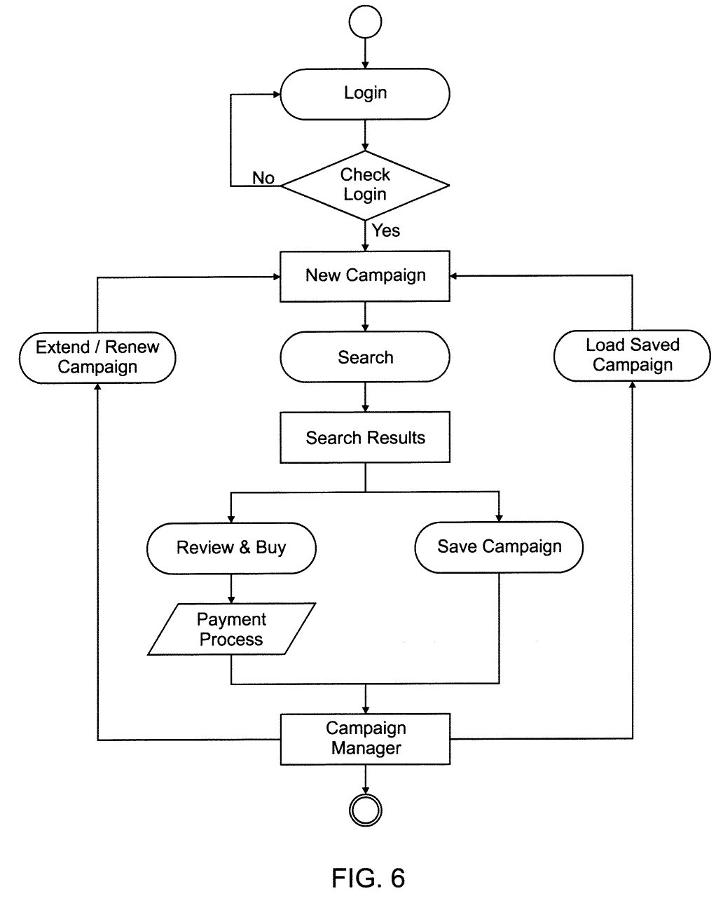

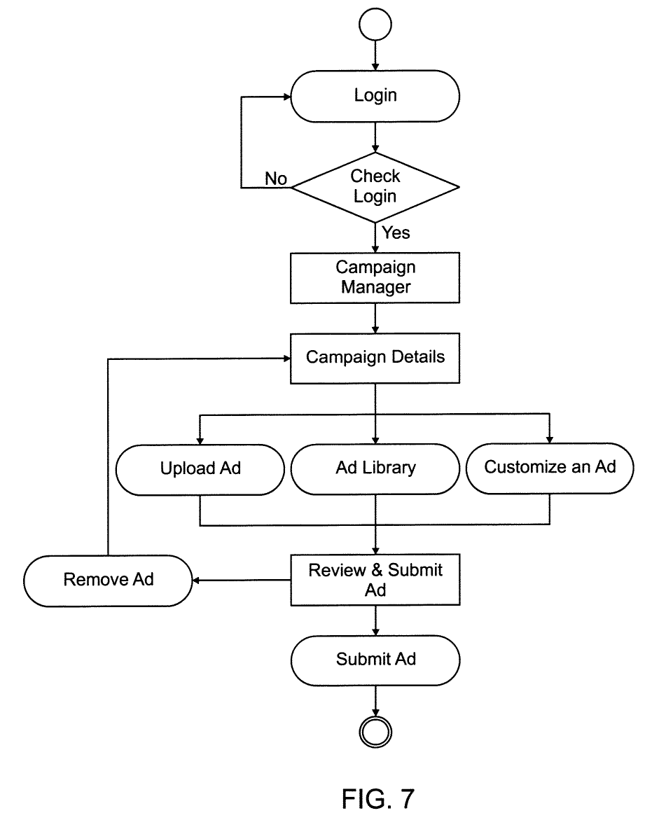

FIGS. 6 and 7 are flowcharts showing exemplary aspects of operations that may be performed to implement digital out-of-home advertisements according to one aspect of the invention.

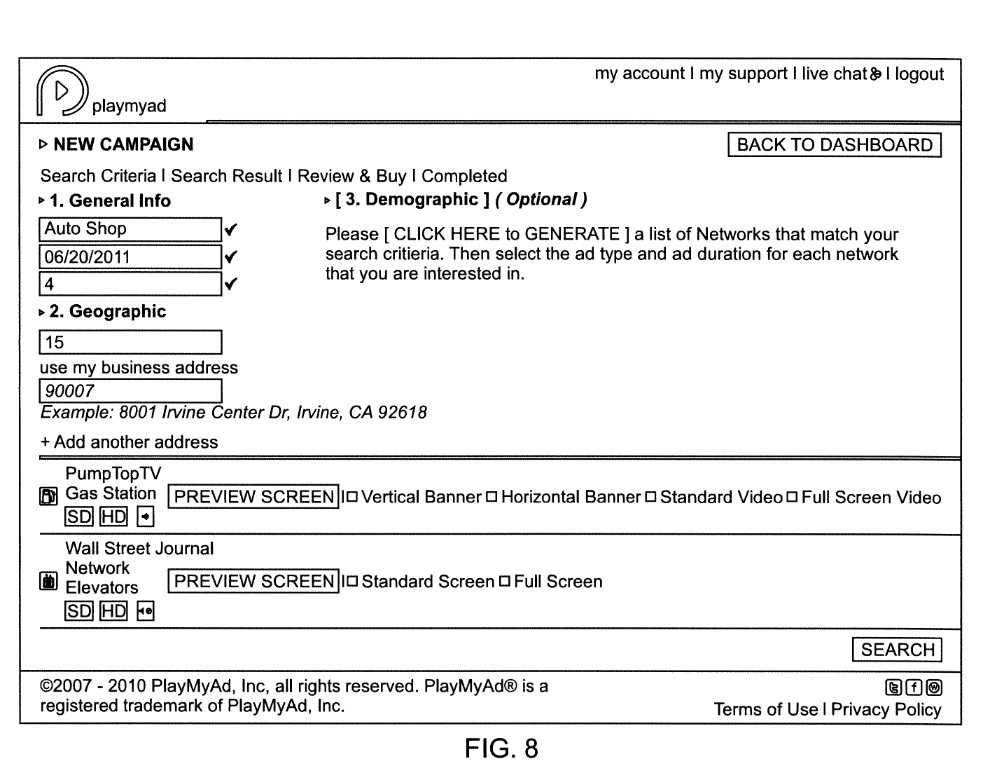

FIGS. 8, 9, 10, and 11 illustrate simplified user screens with exemplary aspects of the web-based system to implement digital out-of-home advertisement according to one aspect of the invention.

As shown in FIG. 1, a web browser 102 is generally a software application for retrieving, presenting, and traversing information resources on the World Wide Web. An information resource is identified by a Uniform Resource Identifier (URI) and may be a web page, image, video, or other piece of content. Hyperlinks present in information resources enable users to easily navigate their browsers to related resources. Although browsers are primarily intended to access the World Wide Web, they can also be used to access information provided by web servers in private networks or files in file systems. Examples of popular web browsers include Windows Internet Explorer, Mozilla Firefox, Apple Safari, Google Chrome, and Opera.

Adobe Flash 104 (formerly SmartSketch FutureSplash, FutureSplash Animator and Macromedia Flash) is a multimedia platform used to add animation, video, and interactivity to web pages. Flash is frequently used for advertisements and games. More recently, it has been positioned as a tool for “Rich Internet Applications” (“RIAs”). In general, Flash manipulates vector and raster graphics to provide animation of text, drawings, and still images. It supports bidirectional streaming of audio and video, and it can capture user input via mouse, keyboard, microphone, and camera. Flash contains an object-oriented language called ActionScript. Flash content may be displayed on various computer systems and devices, using Adobe Flash Player, which is available free of charge for common web browsers, some mobile phones and a few other electronic devices (using Flash Lite).

JavaScript 106, also known as ECMAScript, is a prototype-based, object-oriented scripting language that is dynamic, weakly typed and has first-class functions. It is also considered a functional programming language like Scheme and OCaml because it has closures and supports higher-order functions.

JavaScript is generally an implementation of the ECMAScript language standard and is primarily used in the form of client-side JavaScript, implemented as part of a web browser in order to provide enhanced user interfaces and dynamic websites. This enables programmatic access to computational objects within a host environment.

JavaScript's use in applications outside web pages—for example in PDF documents, site-specific browsers and desktop widgets—is also significant. Newer and faster Javascript VMs and frameworks built upon them (notably Node.js) have also increased the popularity of Javascript for server-side web applications.

HTML 108, which stands for Hyper Text Markup Language, is the predominant markup language for web pages. HTML is the basic building-blocks of web pages. The purpose of a web browser is to read HTML documents and compose them into visual or audible web pages. The browser does not display the HTML tags, but uses the tags to interpret the content of the page.

HTML elements 108 form the building blocks of all websites. HTML allows images and objects to be embedded and can be used to create interactive forms. It provides a means to create structured documents by denoting structural semantics for text such as headings, paragraphs, lists, links, quotes and other items. It can embed scripts in languages such as JavaScript which affect the behavior of HTML web pages.

A web server 124 can be referred to as either the hardware (the computer) or the software (the computer application) that helps to deliver content that can be accessed through the Internet. The most common use of Web servers is to host Web sites but there are other uses like data storage or for running enterprise applications.

PHP 122 is a general-purpose scripting language originally designed for web development to produce dynamic web pages. For this purpose, PHP code is embedded into the HTML source document and interpreted by a web server with a PHP processor module, which generates the web page document. It also has evolved to include a command-line interface capability and can be used in standalone graphical applications. PHP can be deployed on most web servers and as a standalone interpreter, on almost every operating system and platform free of charge. PHP is installed on more than 20 million websites and 1 million web servers.

A web service 124 is a method of communication between two electronic devices over a network. In general, a web service is a software application designed to support interoperable machine-to-machine interaction over a network. The web service has an interface described in a machine-processable format (specifically Web Services Description Language WSDL). Other systems interact with the web service in a manner prescribed by its description using SOAP messages, typically conveyed using HTTP with an XML serialization in conjunction with other Web-related standards.” The W3C also states, “We can identify two major classes of web services, REST-compliant Web services, in which the primary purpose of the service is to manipulate XML representations of Web resources using a uniform set of “stateless” operations; and arbitrary Web services, in which the service may expose an arbitrary set of operations.”

Regarding the PMA client 118, any anonymous users could generally learn about the PMA system through pages: ADVERTISERS page, PARTNERS page, ABOUT US page and CONTACT US page. Through the Web Server, which are expressed in HTML Pages, System Server Pages (PHP) of PMA perform the following functions:

1. Searching Locations 114: This function shall have been searching for locations. The function will search the PMA Database for available locations and may also search the Advertising Network's (ADTEK) Database which would be approved from the database 128 of the Advertising Network Server 122 through Web service. The locations will be shown on Google map using Google API 126.

2. Payment 116: To implement advertising strategies on the locations have been selected, the customer must make the payment through system PMA. Once this is done, the system will check approval of the locations from PMA database and may also check approval of locations via the Advertising Network server 122 (such as the ADTEK server) via Web Service.

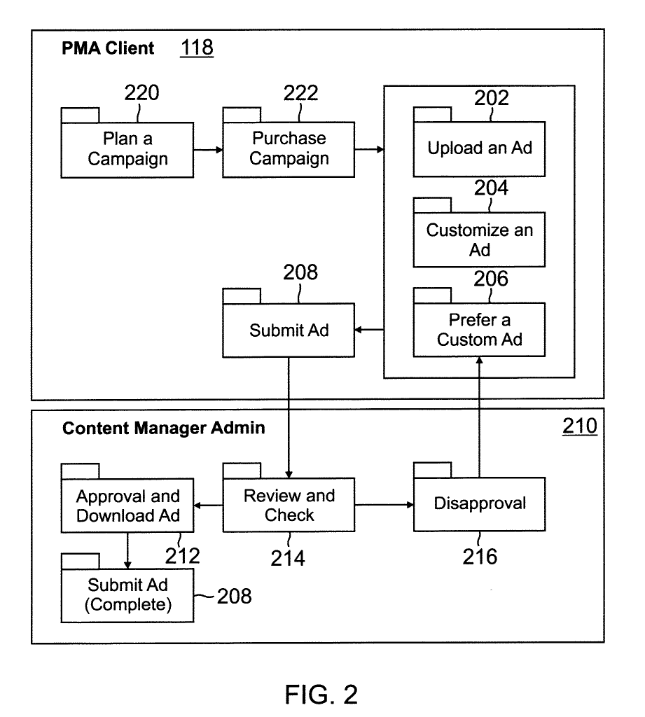

Turning to FIG. 2, in one embodiment, customers should plan a campaign 220 to implement the advertising strategy on the system. To plan a campaign 220, the customers need to enter the information needed to create a campaign, such as Campaign name, Start Date, Number of Weeks, etc., as shown in the screen shot illustrated in FIG. 8.

As seen in FIG. 8, when the customers or advertisers click the “click here to Generate” link, the PMA system will generate a list of relevant ad networks and the various ad types that may be offered to match the advertisers' search criteria. Advertisers could then select the types of ad space they are interested in purchasing on each respective advertising network.

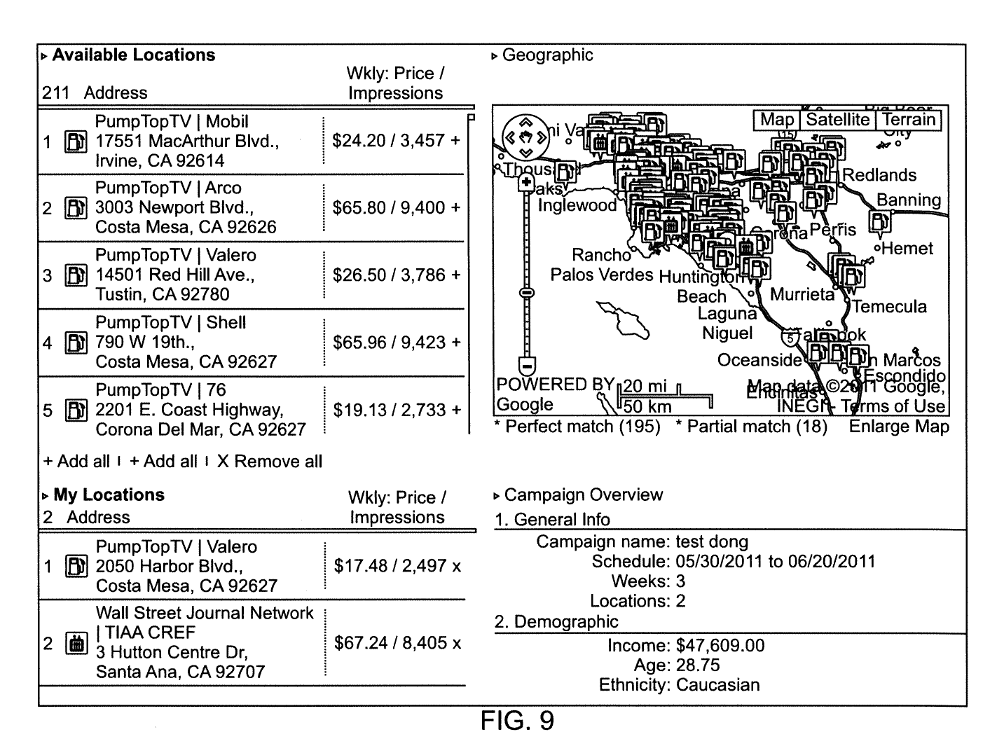

In addition, with the function “Searching locations”, customers will select locations (shown in FIG. 9) to advertise their products based on a list of approved locations with the “Searching locations” function, and will eventually purchase the advertising campaign through the “Payment” function. In one embodiment, customer also has ability to preview the advertising location via Google street view accessible by the Google map.

After purchasing a campaign 222, customers could manage their campaigns and upload their ads. In one embodiment, customers have three options for the creation and submission of their ads:

1. Upload an Ad 202—Customers or users could upload an ad directly to the campaigns.

2. Customize an Ad 204—Customers could select and customize an ad template from the Ad Library.

3. Create a Custom Ad 206—Customers could order a custom ad by filling out the online “creative questionnaire.”

Once the ad has been uploaded, the ad should be submitted 208. The content manager admin 210 tracks the progress of the customers' campaigns, as well as reviews and checks 214, and approve 212 the ad file submitted by the customers. If the submitted ad file is invalid or has content that is not healthy, content manager admin could disapprove 216 the ad file, and require the customer or user to upload a new ad file.

Turning to FIG. 3, this figure illustrates a more detail model of the location search function of the system in accordance with one embodiment of the invention. In one embodiment, each location has latitude and a longitude that could be used to show the location on Google Map using Google API 126. Furthermore, in another embodiment, after creating new networks and locations, the data about the networks and locations is stored in the PMA database (My SQL) 302.

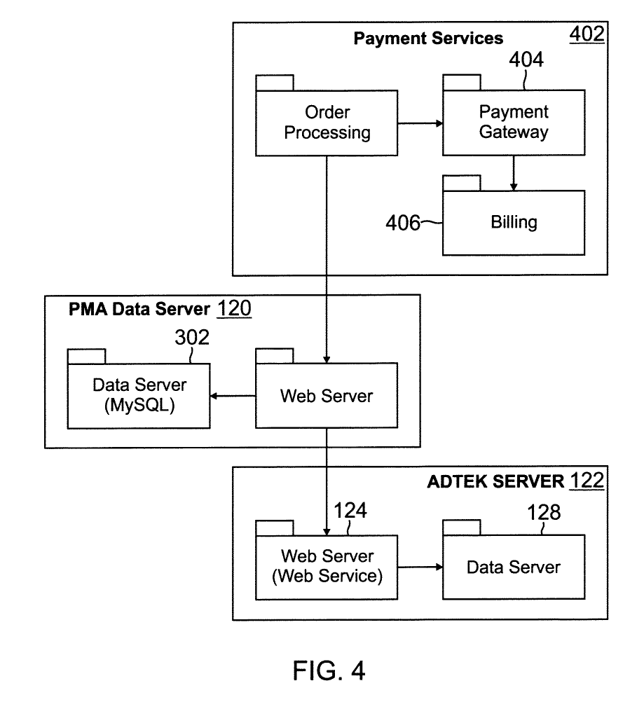

As shown in FIG. 4, a payment gateway 404 is generally an e-commerce application service provider service that authorizes payments for e-businesses, online retailers, bricks and clicks, or traditional brick and mortar. It is the equivalent of a physical point of sale terminal located in most retail outlets. Payment gateways 404 protect credit card details by encrypting sensitive information, such as credit card numbers, to ensure that information is passed securely between the customer and the merchant and also between merchant and the payment processor.

A bill or invoice generated by the billing application 406 is a document requesting payment for an order previously supplied. Presentation of a bill is common practice on the part of credit card companies, utilities, and other service providers. The bill is the total price of all services and goods that are received but not paid, and is presented with the expectation of payment by a due date. In countries where wire transfer is the preferred method of settling debts the printed bill will contain the bank account number of the debtor and usually a reference code identifying the payer. When a bill is paid for, as a part of the transaction, the company will usually provide a bill confirmation.

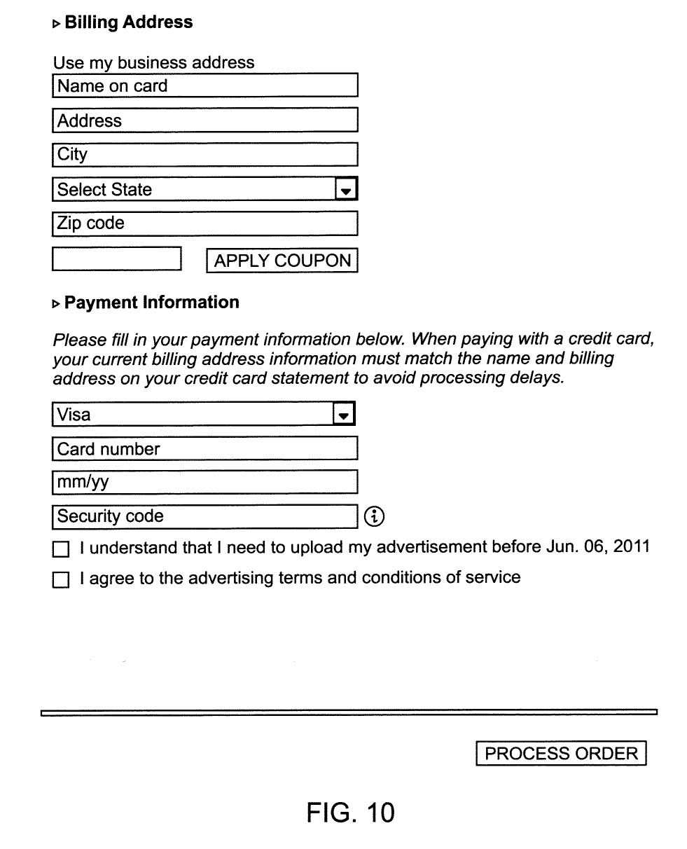

FIG. 4 illustrates a more detail model of the payment function of the system in accordance with one embodiment of the invention. To purchase a campaign, the customer must make the payment through Payment Services 402. In Payment Services 402, the system will check the information about the Payment Gateway 404, then the Billing Address (as illustrated in FIG. 10).

Before the payment could be made, the locations should be checked on the database of PMA Server 120. In addition, the PMA Server 120 may also check to see whether the locations are available on the database 128 of the Advertising Network Server 122.

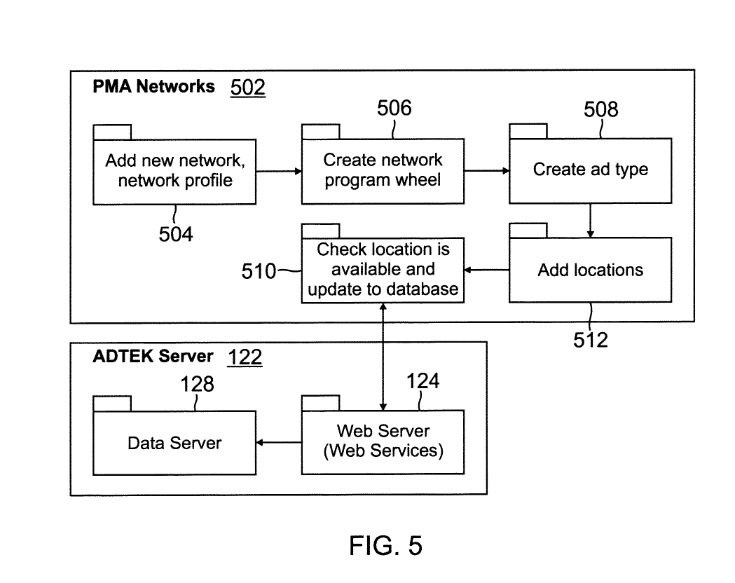

FIG. 5 is a simplified block diagram showing exemplary aspects of managing an advertisement network 502 within the inventive PMA system. In general, an advertisement network in the inventive system is a conglomerate or group of advertising companies and service providers. As shown in FIG. 5, in adding a new advertisement network to the system in accordance with one embodiment, the new network should be created 506 first with the following information:

Company Information—Includes Company name, Venue type, Address, city, state, zip code, phone, and email address.
Station TVS—Includes Locations, screens, DMA's, and visitors/month.

### Programming—Includes Duration and Content.

### Overview

### Audience

### Media Gallery

In general, each advertisement network will have a network profile, contains information about that network. In one embodiment, the information show in the network profile includes:

Company Information—Shows the information about the company network, including Company name, Logo, Venue type, Address, Telephone number, and email address.
Station TVS—Shows the information about the station, including Locations, screen, DMA's, Visitors, Audio, Standard Video, and High Definition Video.

### Programming—Includes Duration and Content.

Audience—Shows the profile or information about the audience that the ad targets.
Overview—Shows the overview information of the advertisement network.
Media Gallery—Shows slide gallery from the images and videos.

The network profile information listed and discussed above for illustration purposes only, and could be expanded to include additional characteristics.

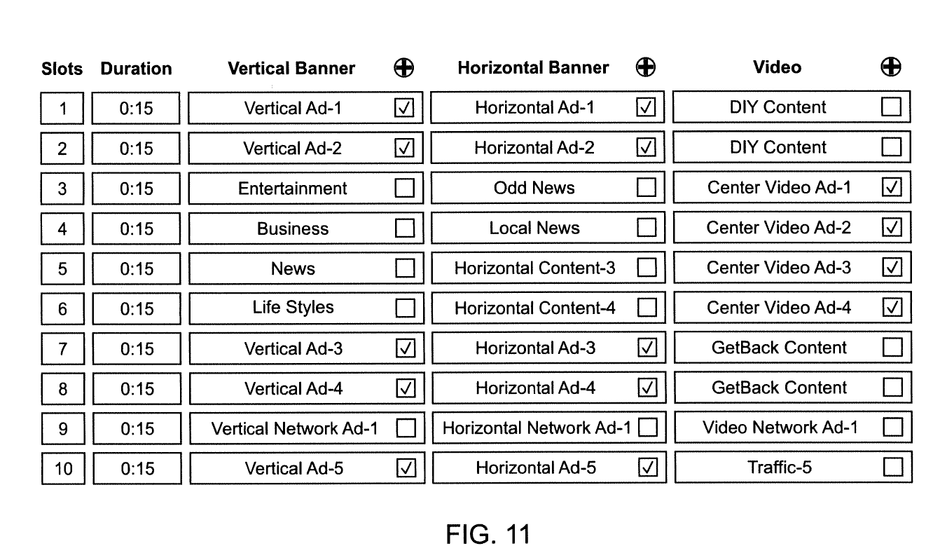

Turning back to FIG. 5, in one embodiment, the system will create a network program wheel (as shown in FIG. 11) to manage time slots in the advertisement network after one or more advertisement networks is created. In this embodiment, the network program wheel includes “Ad Type” products. Furthermore, for each product, there is a list price under the slot. In addition, the function “Searching locations” is based on two data constructs: program wheel and products.

Also as shown in FIG. 5, in one embodiment, the function of “Add locations” is used to create the new location with the following information: Network Identification, Site Brand, Address, City, State, Zip code, In/Outdoor, Number of Screens, and DMA. Furthermore, the following demographic information would be included: Age, Gender, Income, Ethnicity, and Impression. Furthermore, when a location is submitted, it is saved to the PMA database. In some cases the system may also check the database of an Advertising Network's server 120 (such as the ADTEK Server) via Web Services 124 to see whether the location is available.

FIGS. 6 and 7 are flowcharts showing exemplary aspects of operations that may be performed to implement digital out-of-home advertisements. In general, the operations of FIGS. 6 and 7 are illustrated in FIGS. 1 through 5, and discussed and described above.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method to implement digital out-of-home advertisements, comprising:
logging in an advertisement system;
starting an advertisement campaign;
searching for locations where advertisements can be shown;
selecting and purchasing advertisement space;
creating an advertisement from ad templates;
uploading and submitting the advertisement to an appropriate advertising network for display; and
managing information related to the advertisement campaign, and proof of play.

2. The method of claim 1, further comprises creating a network program wheel to manage time slots in an advertisement network.

3. The method of claim 2, further comprises creating a network profile to manage the advertisement network.

4. The method of claim 3, wherein the network profile includes company information, station information, programming information, and audience information.

5. The method of claim 1, further comprises customizing an existing advertisement available in an advertisement database.
